(19) United States
(12) Patent Application Publication
(10) Pub. No.: US 2022/0156833 A1
(43) Pub. Date: May 19, 2022

(54) SYSTEMS AND METHODS FOR DETECTING INTEREST AND VOLUME MATCHING

(71) Applicant: CFPH, LLC, New York, NY (US)

(72) Inventors: Howard W. Lutnick, New York, NY (US); Stuart P. Taylor, London (GB); Howard O. Hoskin, London (GB); Oliver J. Boyle, London (GB); Arran E. Rowsell, London (GB); Paul M. Mutter, New York, NY (US)

(21) Appl. No.: 17/591,165

(22) Filed: Feb. 2, 2022

Related U.S. Application Data
(63) Continuation-in-part of application No. 17/002,555, filed on Aug. 25, 2020.
Application No. 17/002,555 is a continuation of application No. 13/888,352, filed on May 6, 2013, now abandoned.
(60) Provisional application No. 61/820,147, filed on May 6, 2013.
(60) Provisional application No. 61/642,610, filed on May 4, 2012.

(51) Int. Cl. G06Q 40/04

(52) U.S. Cl. CPC G06Q 40/04

(57) ABSTRACT

Various embodiments are directed to a trading system and method for identifying interest and qualifying users to participate in an auction. The system may receive indicia indicating a first user's desire to trade a product or type. The system may determine that there is no matching counter-interest in the product or type. The system may qualify a subset of users to participate in an auction for the trading product based on each user's portfolio, order history, trade history, or specified interest. The system may determine an auction price for the trading product. Each user may view the trading product, the price, the auction start time, and fields for entering a bid or offer volume. The system may start the auction at the designated price for the subset of users. The system may match and execute all or portions of a bid and offer received before the end of the auction.

### CROSS-REFERENCE TO RELATED APPLICATIONS

This application is a continuation-in-part of U.S. patent application Ser. No. 17/002,555 filed Aug. 25, 2020, which is a continuation of U.S. patent application Ser. No. 13/888,352 filed May 6, 2013, which claims the benefit of U.S. Provisional Patent Application No. 61/642,610 filed May 4, 2012 and U.S. Provisional Application No. 61/820,147 filed May 6, 2013, the disclosures of which are incorporated herein by reference in its entireties.

### FIELD OF THE INVENTION

This application generally relates to trading and matching buyers and sellers of trading products, e.g., electronically.

### BACKGROUND

Traders often do not wish to reveal their interest in buying or selling quantities of trading products such as financial instruments like fixed income securities, or to reveal the price at which they would be willing to trade such instruments. Many traders instead prefer to passively wait for another trader to publish an order, and then hit or lift the order if it fits their interest. In some cases where interest is not revealed, there may be mutually agreeable prices and quantities at which two traders would be willing to transact if only they know of the other's opposing interest.

### BRIEF SUMMARY

Various embodiments are directed to detecting interest in a trading product and enabling two or more parties to trade in the product, e.g., via an auction. Participation in the auction or other trading mechanism may be limited to a subset of users for whom interest has been identified by the system. A trading price may be determined by one or more of the trading parties. In one embodiment, the system automatically, or a non-trading agent associated with the system, may suggest a level at which an auction may be run. An auction may be conducted, e.g., anonymously, at a suggested trading price.

Various embodiments are directed to trading systems, methods, and computer-readable media for identifying interest in trading products by two or more potentially interested trading participants and enabling those participants to trade volume of the trading product. In some embodiments, trading participants do not reveal their identities and/or the existence of their interest at least until the trade occurs. The system may receive indicia indicating a first user's desire to trade a product or type. The system may determine that there is no matching counter-interest in the product or type. The system may qualify a subset of users, such as human users or computers executing trading algorithms, to participate in an auction for the trading product based on each user's portfolio, order history, trade history, or specified interest. The system may determine an auction price for the trading product. Each user may view the trading product, the price, the auction start and end times, and fields for entering a bid or offer volume. The system may start the auction at the suggested price for the subset of users. The system may match and execute all or portions of a bid and offer received before the end of the auction.

In some embodiments, the price may be determined automatically as a midpoint between a best bid price and a best offer price of the trading product.

In some embodiments, the suggested trading price may be specified by the first user, another user, the system, or another party, e.g., a neutral third party who does not participate in the auction. In some embodiments, the price is a determined fair market value for the trading product, e.g., determined based on one or more prior trade prices for the trading product.

In some embodiments, determining a trading price of the trading product may involve determining that the trading product is illiquid, transmitting a request for a human to determine a price for the trading product, and receiving from a human the trading price for the trading product.

In some embodiments, the identity of the auction participants may not be revealed to one another, e.g., prior to the end of the auction. In some embodiments, anonymity of those qualified to view interest or participate in the auction may be maintained, e.g., at least until the end of the auction.

In some embodiments, the existence of any interest to purchase or sell the trading product is not disclosed to the users qualified to participate in the auction, e.g., prior to the end of the auction.

In some embodiments, a user's interest (such as the first user's interest) may be determined from a user's prior order to purchase or sell a quantity of the trading product.

In some embodiments, the system may determine that there is no contra interest by searching the electronic marketplace, which may include liquidity sources internal or associated with the system or liquidity sources external to the system, and determining that there is no order contra to a first user's order for the trading product.

In some embodiments, the system may receive from the first user an indicia of interest in trading a type of trading product.

In some embodiments, the system may receive from the first user a request to initiate an auction for the first trading product.

In some embodiments, prior to receiving indicia indicating that the first user desires to trade, the system may qualify the first user to view interest information in the trading product or type based on at least one of (a) a portfolio of the first user, (b) at least one prior trade by the first user in the trading product or type, (c) at least one prior order by the first user for a quantity of the trading product or another trading product of the type, (d) at least one current order by the first user for a quantity of the one of (1) the trading product and (2) a trading product of the type, and (e) trading interest specified by the first user in the one of (1) the trading product, (2) the type of trading product, and (3) another trading product of the type.

In some embodiments, a user may be qualified to view interest or participate in the auction based on the user previously submitting at least one order for the trading product that satisfies a predetermined minimum quantity threshold and a predetermined minimum duration threshold. For example, a user may be qualified to view interest or participate in the auction if the user has traded the trading product or a related product within a past number of days, such as five or ten trading days or 30, 60, or 365 days. The time period may be measured against (1) the time of qualifying, (2) the auction start time, (3) the auction end time, and (4) the day of the auction.

In some embodiments, the act of receiving indicia indicating that a first user desires to trade may be responsive to a failed negotiation between the first user and another user to trade the trading product. The auction may be started in response to the failed negotiation.

### BRIEF DESCRIPTION OF THE FIGURES

FIG. 1 depicts a system according to at least one embodiment of the systems disclosed herein.

FIG. 2 depicts a flow diagram according to at least one embodiment of the methods disclosed herein.

FIG. 3 depicts a flow diagram according to at least one embodiment of the methods disclosed herein.

### DETAILED DESCRIPTION

The following sections I-VII provide a guide to interpreting the present application.

### I. Terms

The term “product” means any machine, manufacture and/or composition of matter, unless expressly specified otherwise.

The term “process” means a process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere description of a process, or in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the invention”, unless expressly specified otherwise.

The term “variation” of an invention means an embodiment of the invention, unless expressly specified otherwise.

The term “indication” is used in an extremely broad sense. An “indication” of a thing should be understood to include anything that may be used to determine the thing.

An indication of a thing may include an electronic message that identifies the thing (e.g., an identification of a widget by a serial number affixed to the widget, an identification of a widget by one or more characteristics of the widget). An indication of a thing may include information that may be used to compute and/or look-up a thing (e.g., information identifying a machine of which a widget is a part that may be used to determine the widget). An indication of a thing may specify things that are related to the thing (e.g., characteristics of the thing, a name of the thing, a name of a thing related to the thing). An indication of a thing may not specify things that are related to the thing (e.g., a letter “a” may be an indication of a widget of a computer system that is configured to interpret the letter “a” to identify the widget). An indication of a thing may include a sign, a symptom, and/or a token of the thing. An indication, for example, may include a code, a reference, an example, a link, a signal, and/or an identifier. An indication of a thing may include information that represents, describes, and/or otherwise is associated with the thing.

A transformation of an indication of a thing may be an indication of the thing (e.g., an encrypted indication of a thing may be an indication of the thing). An indication of a thing may include the thing itself, a copy of the thing, and/or a portion of the thing. An indication of a thing may be meaningless to a thing that is not configured to understand the indication (e.g., a person may not understand that a letter “a” indicates a widget but it may nonetheless be an indication of the widget because the computer system may determine the widget from the letter “a”). It should be understood that the fact that an indication of a thing may be used to determine the thing does not mean that the thing or anything else is determined. An indication of a thing may include an indication of any number of the thing unless specified otherwise. An indication of a thing may include an indication of other things (e.g., an electronic message that indicates may things). (Indication can be used as a very broad term in claim language. For example: receiving an indication of a financial instrument.)

The term “represent” means (1) to serve to express, designate, stand for, or denote, as a word, symbol, or the like does; (2) to express or designate by some term, character, symbol, or the like; (3) to portray or depict or present the likeness of, as a picture does; or (4) to serve as a sign or symbol of.

A reference to “another embodiment” in describing an embodiment does not imply that the referenced embodiment is mutually exclusive with another embodiment (e.g., an embodiment described before the referenced embodiment), unless expressly specified otherwise. Similarly, the mere fact that two (or more) embodiments are referenced does not imply that those embodiments are mutually exclusive.

One embodiment of the invention may include or cover or embrace more than one other embodiment of the invention. For example, a first embodiment comprising elements a, b, and c may cover a second embodiment that comprises elements a, b, c, and d as well as a third embodiment covering elements a, b, c, and e. Similarly, each of the first, second, and third embodiments may cover a fourth embodiment comprising elements a, b, c, d, and e.

The terms “including”, “comprising” and variations thereof mean “including but not necessarily limited to”, unless expressly specified otherwise. Thus, for example, the sentence “the machine includes a red widget and a blue widget” means the machine includes the red widget and the blue widget, but may possibly include one or more other items as well.

The term “consisting of” and variations thereof mean “including and also limited to”, unless expressly specified otherwise. Thus, for example, the sentence “the machine consists of a red widget and a blue widget” means the machine includes the red widget and the blue widget, but does not include anything else.

The term “compose” and variations thereof mean “to make up the constituent parts of, component of or member of”, unless expressly specified otherwise. Thus, for example, the sentence “the red widget and the blue widget compose a machine” means the machine includes the red widget and the blue widget.

The term “exclusively compose” and variations thereof mean “to make up exclusively the constituent parts of, to be the only components of, or to be the only members of”, unless expressly specified otherwise. Thus, for example, the sentence “the red widget and the blue widget exclusively compose a machine” means the machine consists of the red widget and the blue widget (i.e. and nothing else).

The terms “a”, “an” and “the” refer to “one or more”, unless expressly specified otherwise. Thus, for example, the phrase “a widget” means one or more widgets, unless expressly specified otherwise. Similarly, after reciting the phrase “a widget”, a subsequent recitation of the phrase “the widget” means “the one or more widgets”. Accordingly, it should be understood that the word “the” may also refer to a specific term having antecedent basis. For example, if a paragraph mentions “a specific single feature” and then refers to “the feature,” then the phrase “the feature” should be understood to refer to the previously mentioned “a specific single feature.” (It should be understood that the term “a” in “a specific single feature” refers to “one” specific single feature and not “one or more” specific single features.)

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of” each of the plurality of things. For example, the phrase “at least one of a widget, a car and a wheel” does not mean “one widget, one car and one wheel”.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” covers both “based only on” and “based at least on”. The phrase “based at least on” is equivalent to the phrase “based at least in part on”. For example, the phrase “element A is calculated based on element B and element C” covers embodiments where element A is calculated as the product of B times C (in other words, A=B×C), embodiments where A is calculated as the sum of B plus C (in other words, A=B+C), embodiments where A is calculated as a product of B times C times D, embodiments where A is calculated as a sum of the square root of B plus C plus D times E, and so on.

The term “represent” and like terms are not exclusive, unless expressly specified otherwise. For example, the term “represents” does not mean “represents only”, unless expressly specified otherwise. For example, the phrase “the data represents a credit card number” covers both “the data represents only a credit card number” and “the data represents a credit card number and the data also represents something else”.

The term “whereby” is used herein only to precede a clause or other set of words that express only the intended result, objective or consequence of something that is explicitly recited before the term “whereby”. Thus, when the term “whereby” is used in a claim, the clause or other words that the term “whereby” modifies do not establish specific further limitations of the claim or otherwise restrict the meaning or scope of the claim.

The terms “e.g”, “such as” and like terms mean “for example”, and thus do not limit the term or phrase they explain. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first of the two machines has a function and the second of the two machines has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

A numerical range includes integers and non-integers in the range, unless expressly specified otherwise. For example, the range “1 to 10” includes the integers from 1 to 10 (e.g., 1, 2, 3, 4, . . . 9, 10) and non-integers (e.g., 1.0031415926, 1.1, 1.2, . . . 1.9).

Where two or more terms or phrases are synonymous (e.g., because of an explicit statement that the terms or phrases are synonymous), instances of one such term or phrase does not mean instances of another such term or phrase must have a different meaning. For example, where a statement renders the meaning of “including” to be synonymous with “including but not limited to”, the mere usage of the phrase “including but not limited to” does not mean that the term “including” means something other than “including but not limited to

### II. Determining

The term “determining” and grammatical variants thereof (e.g., to determine a price, determining a value, the determination of an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), rendering into electronic format or digital representation, ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing, averaging and the like.

The term “determining” does not imply that mathematical processing must be performed, and does not imply that numerical methods must be used, and does not imply that an algorithm is used.

The term “determining” does not imply that any particular device must be used. For example, a computer need not necessarily perform the determining.

The term “determining” may include “calculating”. The term “calculating” should be understood to include performing one or more calculations. Calculating may include computing, processing, and/or deriving. Calculating may be performed by a computing device. For example, calculating a thing may include applying an algorithm to data by a computer processor and generating the thing as an output of the processor.

The term “determining” may include “referencing”. The term “referencing” should be understood to include making one or more reference, e.g., to a thing. Referencing may include querying, accessing, selecting, choosing, reading, and/or looking-up. The act of referencing may be performed by a computing device. For example, referencing a thing may include reading a memory location in which the thing is stored by a processor.

The term “determining” may include “receiving”. For example, receiving a thing may include taking in the thing. In some embodiments, receiving may include acts performed to take in a thing, such as operating a network interface through which the thing is taken in. In some embodiments, receiving may be performed without acts performed to take in the thing, such as in a direct memory write or a hard-wired circuit. Receiving a thing may include receiving a thing from a remote source that may have calculated the thing.

### III. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to that limitation (e.g., “the widget”), this mere usage does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term, but that ordinal number does not have any other meaning or limiting effect—it is merely a convenient name. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. The mere usage of ordinal numbers does not define a numerical limit to the features identified with the ordinal numbers. For example, the mere usage of the ordinal numbers “first” and “second” before the term “widget” does not indicate that there are exactly two widgets.

When a single device, article or other product is described herein, in another embodiment more than one device or article (whether or not they cooperate) may alternatively be used in place of the single device or article that is described. Accordingly, the functionality that is described as being possessed by a device may alternatively be possessed by more than one device or article (whether or not they cooperate) in another embodiment.

Similarly, where more than one device, article or other product is described herein (whether or not they cooperate), in another embodiment a single device or article may alternatively be used in place of the more than one device or article that is described. For example, a plurality of computer-based devices may be substituted with a single computer-based device. In some embodiments, such a plurality of computer-based devices may operate together to perform one step of a process such as is common in grid computing systems. In some embodiments, such a plurality of computer-based devices may operate provide added functionality to one another so that the plurality may operate to perform one step of a process such as is common in cloud computing systems. (Conversely, a single computer-based device may be substituted with multiple computer-based devices operating in cooperation with one another. For example, a single computing device may be substituted with a server and a workstation in communication with one another over the internet). Accordingly, the various functionality that is described as being possessed by more than one device or article may alternatively be possessed by a single device or article.

The functionality and/or the features of a single device that is described may, in another embodiment, be alternatively embodied by one or more other devices which are described but are not explicitly described as having such functionality or features. Thus, other embodiments need not include the described device itself, but rather can include the one or more other devices which would, in those other embodiments, have such functionality or features.

### IV. Disclosed Examples and Terminology are not Limiting

Neither the Title (set forth at the beginning of the first page of the present application) nor the Abstract (set forth at the end of the present application) is to be taken as limiting in any way the scope of the disclosed invention, is to be used in interpreting the meaning of any claim or is to be used in limiting the scope of any claim. An Abstract has been included in this application merely because an Abstract is required under 37 C.F.R. § 1.72(b).

The headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The disclosed invention is widely applicable to numerous embodiments, as is readily apparent from the disclosure. One of ordinary skill in the art will recognize that the disclosed invention may be practiced with various modifications and alterations, such as structural, logical, software, and electrical modifications. Although particular features of the disclosed invention may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not be interpreted as requiring features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or (with respect to a claim and the invention defined by that claim) expressly recited in that claim.

Any preambles of the claims that recite anything other than a statutory class shall be interpreted to recite purposes, benefits and possible uses of the claimed invention, and such preambles shall not be construed to limit the claimed invention.

The present disclosure is not a literal description of all embodiments of the invention. Also, the present disclosure is not a listing of features of the invention which must be present in all embodiments.

All disclosed embodiments are not necessarily covered by the claims (even including all pending, amended, issued and canceled claims). In addition, a disclosed embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g., weeks at a time). In addition, devices that are in communication with each other may communicate directly or indirectly through one or more intermediaries. Devices are in communication with one another if they are capable of at least one-way communication with one another. For example, a first device is in communication with a second device if the first device is capable of transmitting information to the second device. Similarly, the second device is in communication with the first device if the second device is capable of receiving information from the first device.

A description of an embodiment with several components or features does not imply that all or even any of such components or features are required. On the contrary, a variety of optional components are described to illustrate the wide variety of possible embodiments of the present invention. Unless otherwise specified explicitly, no component or feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are preferred, essential or required. Various other embodiments within the scope of the described invention include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, and a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### V. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

The term “compute” shall mean to determine using a processor in accordance with a software algorithm.

A “processor” means one or more microprocessors, central processing units (CPUs), computing devices, microcontrollers, digital signal processors, graphics processing units (GPUs) or like devices or any combination thereof, regardless of the architecture (e.g., chip-level multiprocessing or multi-core, RISC, CISC, Microprocessor without Interlocked Pipeline Stages, pipelining configuration, simultaneous multithreading, microprocessor with integrated graphics processing unit, GPGPU).

A “computing device” means one or more microprocessors, central processing units (CPUs), computing devices, microcontrollers, digital signal processors, graphics card, mobile gaming device, or like devices or any combination thereof, regardless of the architecture (e.g., chip-level multiprocessing or multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process. For example, a description of a process is a description of an apparatus comprising a processor and memory that stores a program comprising instructions that, when executed by the processor, direct the processor to perform the method.

The apparatus that performs the process can include a plurality of computing devices that work together to perform the process. Some of the computing devices may work together to perform each step of a process, may work on separate steps of a process, may provide underlying services that other computing devices that may facilitate the performance of the process. Such computing devices may act under instruction of a centralized authority. In another embodiment, such computing devices may act without instruction of a centralized authority. Some examples of apparatus that may operate in some or all of these ways may include grid computer systems, cloud computer systems, peer-to-peer computer systems, computer systems configured to provide software as a service, and so on. For example, the apparatus may comprise a computer system that executes the bulk of its processing load on a remote server but outputs display information to and receives user input information from a local user computer, such as a computer system that executes VMware software.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

The term “tangible computer-readable medium” refers to a “computer-readable medium” that comprises a hardware component, such as optical or magnetic disks.

Various forms of computer readable media may be involved in carrying data (e.g., sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), wireless local area network communication defined by the IEEE 802.11 specifications whether or not they are approved by the WiFi Alliance, SAP, ATP, Bluetooth™, and TCP/IP, TDMA, CDMA, and 3G; and/or (iv) encrypted to ensure privacy or prevent fraud in any of a variety of ways well known in the art.

The term “database” refers to any electronically-stored collection of data that is stored in a retrievable format.

The term “data structure” refers to a database in a hardware machine such as a computer.

The term “network” means a series of points or nodes interconnected by communication paths. For example, a network can include a plurality of computers or communication devices interconnected by one or more wired and/or wireless communication paths. Networks can interconnect with other networks and contain subnetworks.

The term “predetermined” means determined beforehand, e.g., before a present time or a present action. For example, the phrase “displaying a predetermined value” means displaying a value that was determined before the act of displaying.

The term “condition” means (1) a premise upon which the fulfillment of an agreement depends, or (2) something essential to the appearance or occurrence of something else.

The term “transaction” means (1) an Exchange or transfer of goods, services, or funds, or (2) a communicative action or activity involving two parties or things that reciprocally affect or influence each other.

Thus a description of a process is likewise a description of a computer-readable medium storing a program for performing the process. The computer-readable medium can store (in any appropriate format) those program elements which are appropriate to perform the method. For example, a description of a process is a description of a computer-readable storage medium that stores a program comprising instructions that, when executed by a processor, direct the processor to perform the method.

Just as the description of various steps in a process does not indicate that all the described steps are required, embodiments of an apparatus include a computer or computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial online service providers, bulletin board systems, a satellite communications link, a combination of any of the above). Each of the devices may themselves comprise computers or other computing devices, such as those based on the Intel®, Pentium®, or Centrino™, Atom™ or Core™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

As used herein, the term “encryption” refers to a process for obscuring or hiding information so that the information is not readily understandable without special knowledge. The process of encryption may transform raw information, called plaintext, into encrypted information. The encrypted information may be called ciphertext, and the algorithm for transforming the plaintext into ciphertext may be referred to as a cipher. A cipher may also be used for performing the reverse operation of converting the ciphertext back into plaintext. Examples of ciphers include substitution ciphers, transposition ciphers, and ciphers implemented using rotor machines.

In various encryption methods, ciphers may require a supplementary piece of information called a key. A key may consist, for example, of a string of bits. A key may be used in conjunction with a cipher to encrypt plaintext. A key may also be used in conjunction with a cipher to decrypt ciphertext. In a category of ciphers called symmetric key algorithms (e.g., private-key cryptography), the same key is used for both encryption and decryption. The sanctity of the encrypted information may thus depend on the key being kept secret. Examples of symmetric key algorithms are DES and AES. In a category of ciphers called asymmetric key algorithms (e.g., public-key cryptography), different keys are used for encryption and decryption. With an asymmetric key algorithm, any member of the public may use a first key (e.g., a public key) to encrypt plaintext into ciphertext. However, only the holder of a second key (e.g., the private key) will be able to decrypt the ciphertext back into plaintext. An example of an asymmetric key algorithm is the RSA algorithm.

### VI. Disclaimer

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application will be prefaced by the phrase “does not include” or by the phrase “cannot perform”.

### VII. Incorporation By Reference

Any patent, patent application or other document referred to herein is incorporated by reference into this patent application as part of the present disclosure, but only for purposes of written description and enablement in accordance with 35 U.S.C. § 112, and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference. Conversely, the definitions provided in this application should not be used to limit, define, or otherwise construe any term of any document incorporated herein by reference. The definitions set forth explicitly in this application are controlling notwithstanding the description of particular embodiments that may be incompatible with the definition(s).

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

### DETAILED DESCRIPTION OF EXEMPLARY EMBODIMENTS

Various embodiments are directed to a trading system and method for identifying interest for a trading product in two or more potentially interested trading participants and enabling those participants to trade volume of the trading product. In some embodiments, trading participants do not reveal their identities or the existence of their interest at least until the trade occurs.

Determine Buy and Sell Side Interest

In some embodiments, a Broker System may interrogate one or more counterparties' Order Management Systems (“OMS”) to determine each user's interest in specific trading products or types of trading products. Interest (in one or more specific trading products) may be determined based on one or more factors, such as a user's portfolio (e.g., user's existing portfolio of instruments, such as bonds, which the user may be interested in selling part of or buying more of), e.g., determined via OMS; a user's trading history (e.g., a user may be willing to buy or sell a trading product that the user has previously bought or sold); a user's bids and offers for specific products determined from the OMS (e.g., a user may be willing to buy or sell a trading product that the user is currently trying to buy or sell); user input specifying price and/or quantity (or range) for each trading product or type (e.g., the user may have interest in trading products or types of trading products which the user explicitly identified); and/or other user-specified criteria or categories.

In some embodiments, the system may qualify one or more system users to view part or all of the interest information, e.g., in product or type, e.g., from all or a subset of users.

In some embodiments, a broker system may allow some or all users to see the existence of interest in a product or type, e.g., but not the direction (i.e., cannot see whether interest is to buy or to sell).

In some embodiments, buyers and sellers may see counter-interest under certain conditions, e.g., when buyer and seller criteria mutually match (e.g., as in an exemplary Go Fish model).

In some embodiments, a user may be qualified to view interest or participate in an auction (such as a “Volume Match” style auction), e.g., if the user is sufficiently active in that product or type, e.g., if the user has already traded an amount (e.g., above a threshold amount) of that product or type (e.g., within a past predetermined minimum period of time). In some embodiments, a broker system may check to see if the user actually traded in that security and is not bluffing interest.

In some embodiments, other criteria (e.g., from broker system or user) may govern who can see or trade against one user's interest, such as credit limits; minimum volume traded in the trading product or type; existence of current interest in the trading product or type; and/or exclude “undesirable” traders, e.g., traders who have been identified to be undesirable counterparties based on a set of available rules.

In some embodiments, interest may be disclosed in baskets/types rather than specific products. In other embodiments, the system may selectively disclose one or more of the following: existence of interest in product or type; side of interest (buy or sell); price (or range of prices); and/or quantity (or range of quantities).

In some embodiments, different users may see different levels of information. For example, in some embodiments matched buyers and sellers may see price and quantity, while others may only see existence of interest.

In some embodiments, a broker system may disclose or require interest at various times. For example, a buy-side user may submit interest at 9 am, and sell-side users may see the interest or information related thereto at 10 am. In another example, a sell-side user may submit interest at 1 pm, and sell-side users may see the interest or information related thereto at 5 pm that day or the following day.

In some embodiments, a user may submit interest at 9 am to qualify for an auction at 10 am.

In some embodiments, rules may encourage participation and prevent gaming and information leakage.

For example, in some embodiments rules may specify that trading frequency in the product or type must exceed a minimum threshold.

In another example, in some embodiments rules may forbid excessive order cancelling. Other exemplary rules may specify that orders must exceed a minimum volume and/or duration. Other exemplary rules may specify that order prices must be reasonable.

In some embodiments, penalties may be incurred for violating rules. Penalties for any rule violation may comprise: temporary suspension (e.g., from all auctions, auctions for a specific product or type, or participation in the OMS such as any order matching via the OMS); getting flagged as a “bad” or “undesirable” trader; being disqualified to see counter interest in a specific product or type; being excluded from auctions for a product or type; or getting suspended from all or some auctions for a period of time such as a month if the user fails to trade (e.g., via an auction and/or via the electronic marketplace) in a given period of time such as a month.

In some embodiments, a broker system that implements an invitation auction trading protocol, as discussed below, may determine whether a first user, such as a Sellside trader who is a trading party that is a subscriber to the invitations auction trading protocol, is qualified to trade against an interest of a second user, such as a Buyside trader who is a trading party that is a subscriber to the invitations auction trading protocol, based on a trading venue, for example, a financial exchange or a financial trading platform, through which orders of the first user are facilitated or executed.

Example Flow

The seller may enter actual product inventory (e.g., including volume) into an Order Management System (“OMS,” e.g., as described in the applications incorporated by reference herein).

The buyer may enter criteria and/or interest into its OMS. In some embodiments, the buyer may specify categories or criteria rather than specific products of interest. For example, the buyer may specify interest in a category such as “corporate bonds in tech companies.”

In some embodiments, the broker system may match buyer interest with seller inventory and expose the sellers' inventories to the buy side. In some embodiments, size and/or price may not be disclosed. In some embodiments, anonymity may be maintained. In some embodiments, the buyer may only see seller inventory if the buyer meets certain qualifications and rules (e.g., as described herein).

In some embodiments, the buyer may select a desired product, which may result in the broker system “connecting” the buyer with the seller (preferably anonymously) to negotiate a price and size to trade. Accordingly, the buyer and seller may negotiate terms and trade a negotiated quantity of the product, e.g., at a negotiated price.

In some embodiments, the system may provide the seller with information about the buyer, such as how often the buyer actually buys.

Order Matching and Negotiation

In some embodiments, once matched, the buyer and seller can directly negotiate price and/or quantity, e.g., via a private communication window. In some embodiments, the buyer and seller may remain anonymous to one another (e.g., indefinitely). In some embodiments, the system may reveal their identities to one another after they trade with one another.

In some embodiments, failed negotiations can trigger the system to conduct an auction in the negotiated product. One or both parties to the failed negotiation may request the system to conduct an auction. In some embodiments, the system may automatically initiate auction proceedings upon a failed negotiation. The system may determine a price, such as a mid-market or mid-level price, for example, the midprice between the parties' best bid and offer. In some embodiments, e.g., for highly illiquid trading products, the system may request a fair price determination from a third party.

In some embodiments, perfectly matched firm orders may execute automatically, or upon confirmation from buyer and/or seller. In some embodiments, the execution price may comprise a negotiated price, a midprice, a broker system-determined suggested price, a price based on market data (such as NBBO), or a price determined by another algorithm or source. In some embodiments, additional quantity may be negotiated exclusively between the two parties. In some embodiments, any remaining unfilled quantity may go to one or more of: broker system, Aqua, auction, parties that satisfy specific criteria, other targeted parties/groups, and/or the street.

In some embodiments, the broker system may receive a commission on completed transactions.

In some embodiments, a system may initiate an auction session for an instrument at a suggested mid-level price for a first time period. The suggested mid-level price may be determined based on various market data received by the system. The market data may include real time market information concerning executed trades for an instrument, information of an unfilled quantity of an order for the instrument at a certain price and information of a failed negotiation to trade the instrument at a certain price. The auction session may be initiated for the instrument, when the system determines an indication of interest in the instrument has been received from a first trading party, such as a Sellside trading party who is a subscriber to an auction protocol. The indication of interest in the instrument may be determined based on a request indicating an interest in the instrument received by the system from the first trading party, or from another system or entity affiliated or associated with the first trading party. The system may electronically time a countdown of the first time period and determine, by monitoring the countdown of the first time period, whether the auction session is expired. While the auction session is determined not to be expired, the system may display, over a communication network, on graphical user interfaces (GUIs) of second computing devices of respective second trading parties, such as Buyside trading parties who are also subscribers to the auction protocol, auction notifications indicating that an auction for the instrument at the suggested mid-level price has been initiated, and receive a query responsive to the auction notification from one or more second trading parties. The system desirably may provide an auction notification for the instrument to a second trading party, only when the system determines an indication of interest in the specific instrument was received from at least one first trading party. Each query of a second trading party may indicate an order for the instrument, size of the order and direction (i.e., buy or sell) of the order.

The system may, based on each query received from a respective second trading party, initiate and conduct a request for auction (RFA) session for the corresponding second trading party that transmitted the query. An RFA session may have a duration of a second time period. The system may electronically time a countdown of the second time period, and monitor the countdown of the second time period to determine when the corresponding RFA session is expired. The second time period may desirably be shorter than the first time period. The system may conduct a respective RFA session for one or more second trading parties during an auction session for the instrument at the suggested mid-level price. When the system determines that either the auction session is expired or the RFA session for a second trading party is expired, the system may terminate the RFA session.

Based on initiation of an RFA session, the system may, over the communication network, display RFA session information including information associated with the query from which the RFA session was initiated, at first computing devices of respective first trading parties that are determined to have an interest in the instrument. The first trading parties may be determined based on information provided by the first trading parties and stored in an OMS of the system. In some embodiments, the RFA session information may be routed to a selected first trading party of the first trading parties determined to have an interest in the instrument, based on other criteria such a trading venue with which the first trading party is associated, where the trading venue is indicated in information in the OMS for the first trading party. In some embodiments, the RFA session information may not include a size of the order of interest of the second trading party, direction of the order of interest of the second trading party or identity of the second trading party. The size of the order of interest, direction of the order of interest and the identity of the second trading party may not be disclosed to first trading parties at any time during the auction session, and only be disclosed after the auction session is completed and following execution of trades based on matching an RFA order of a first trading party with at least a portion of the order of a second trading party for an RFA session of the second trading party.

In some embodiments, the system may receive, from a first trading party, an RFA order to trade the instrument associated with an RFA session. In some embodiments, the system may, based on the RFA order, determine whether a match exists between the RFA order and a portion of the order for the instrument associated with the query of the second trading party for the RFA session. In some embodiments, the system may, upon expiration of the auction session, control automatically executing two trades corresponding to the two matched orders that effectuate the interests of the first and second trading parties to trade the instrument at the suggested mid-level price for an RFA session. The two trades may include (i) a first trade having the RFA order on one side, such as a bid for a given size of the instrument at the suggested mid-level price, and the system as a counterparty on the other side that has an offer for the instrument at the given size at the suggested mid-level price, and (ii) a second trade having a portion of the order of the first trading party on one side, such as an offer for a size equal to the portion of the order, and the system as a counter party on the other side that has a bid for the instrument of the size equal to the portion of the order. In some embodiments, the system may, after the two trades effectuating the matched orders are executed, display on the GUIs of the first and second trading computing devices, trade information for the matched orders including the size and direction for the RFA session, and identities of the respective first and second trading parties for the RFA session.

Timing of Auction

In some embodiments, a broker system or user may request or initiate an auction, e.g., at various times.

In some embodiments, a broker system may initiate an auction for a product based on a user request for the auction in the specific product or type.

In some embodiments, a broker system may initiate an auction according to a predetermined schedule. For example, in some embodiments, users may submit their interest in a product or type at 9 am, when the auction is pre-scheduled to start at 10 am the same day.

In some embodiments, a broker system may initiate an auction in the product based on market data (e.g., the existence of one or more bids and offers for the product in the electronic marketplace, such as at least one bid and at least one offer).

In some embodiments, a user may initiate an auction after a transaction with unfilled quantity (e.g., such as Volume Clearing “flash the trade”), or after a failed negotiation.

In some embodiments, a user may initiate or request an auction for any qualifying product at any time. In some embodiments, the broker system may require the user to be qualified to initiate an auction for a specific product or type. In some embodiments, the system may qualify a user to initiate an auction if the user has been active in the product or type, or if the user previously submitted interest in the product or type earlier that day or week, etc.

User Qualification for Auction

In some embodiments, users may be qualified to participate if they have a sufficient connection to the product to be auctioned. For example, a user may be deemed to have a sufficient connection if the user is registered for that product or type (or is watching that product or type), and/or if the user traded that product/type on the Broker system or elsewhere within past day, week, month.

In some embodiments, for a user-initiated auction, the user may invite specific users or types of users to the auction and/or define criteria for qualifying users for the auction. In some embodiments, users may initiate private or invitation-only auctions.

In some embodiments, some auctions may be open to all users and/or the street. In some embodiments, the seller, buyer, and/or broker system may decide and specify whether or when to open an auction to a larger audience.

In some embodiments, “interested” or “qualified” users may have preference or priority over non-qualified or non-interested parties during an auction. These types of embodiments may sometimes be referred to as “pay to play” embodiments. In some embodiments, users who have priority or preference in an auction may have their orders matched and executed ahead of non-preferred users during an auction.

In some embodiments, different criteria may apply to different types of auctions, e.g., based on product type, frequency of trading in that product, types of traders who trade in the product, and other criteria. In some embodiments, a broker system-initiated auction may use different criteria than a user-initiated auction.

Price Discovery for Auction

In some embodiments, the suggested price may be set to the last transacted price (e.g., transaction with unfilled quantity may trigger an auction at same price).

In some embodiments, the suggested price may be set automatically, e.g., based on market data, midprice, black box algorithm.

In some embodiments, the price may be set manually, e.g., by a human affiliated with the electronic marketplace or OMS, or by a third-party service.

In some embodiments, a user may propose a price. The price may be accepted by the system, e.g., based on whether the price is in an approved range (e.g., a range that is determined to be reasonable based on market data for the product, related product, or type).

Volume Match Auction

In some embodiments, the system may disclose the product/type, suggested price, and duration of the auction (e.g., and end time of auction) beforehand to qualified users.

In some embodiments, the system may disclose the number of auction spectators/participants.

In some embodiments, users may submit buy/sell orders during the auction (or, in some embodiments, prior to the start of the auction).

In some embodiments, an auction may run for a predetermined period of time.

In some embodiments, the auction could be extended or re-started as needed. For example, an auction may be extended automatically by one minute if a predetermined minimum threshold of volume is traded during the last 30 seconds (or other time frame) of the auction.

In some embodiments, the broker system may match order volume in time priority.

In some embodiments, execution can occur at the time of match or at the time of close of the auction. In some embodiments, the system may cause a “hammer” to be displayed on user displays at the time of execution.

In some embodiments, users may not (or may) see other orders, users, or executions during the auction. In some embodiments, a user who submits a buy or sell order may not know if there are any counter-orders (or same-side orders). In some embodiments, a user may (or may not) see the user's own executions during the auction. In some embodiments, disclosures to a user at auction close may include the user's volume traded, the total volume traded during the auction, the existence or side of any unfilled quantity, and/or counterparty identity (e.g., with respect to the volume traded by user).

In some embodiments, the broker system may receive a commission on completed transactions.

Example Auction Process Flow:

In some embodiments, if a matched buyer or seller has remaining volume after a successful, failed, or pending negotiation, that user may request the broker system to initiate an auction for that product. In some embodiments, the price for the auction may be the negotiated price at which the buyer and seller transacted. In some embodiments, the auction, once started, may automatically show a “hammer” to indicate a trade occurred at that price.

In some embodiments, if a matched buyer and seller negotiate an agreed price for a product, the Broker system may automatically initiate an auction for the product at the negotiated price. In some embodiments, the auction, once started, may automatically show a “hammer” since there was already a trade at the noted price.

In some embodiments, if a matched buyer and seller cannot agree on a price, the buyer, seller, or broker may initiate or request the Broker System to initiate an auction for the product. In some embodiments, the Broker system may determine the price and initiate an auction session for a predetermined time period during which the system conducts multiple RFA sessions for respective parties, such as Buyside trading parties.

In some embodiments, if a matched buyer and seller negotiate an agreed price, the broker system may automatically initiate an auction for a different product related to the negotiated product. In some embodiments, the price for the different product may be based on the negotiated price.

Disclosure of Transaction Information and Market Data

In some embodiments, various details may be disclosed (or not disclosed) about transactions, such as: product or type, price, quantity, time of transaction, and type or names of transacting parties. In some embodiments, some or all of this data may be disclosed. In other embodiments, some or all of this data may not be disclosed. In some embodiments, different pieces of information may be disclosed at different times. For example, some or all of the data may be disclosed: immediately upon completion of transaction; shortly after transaction; upon occurrence of event (e.g., subsequent transaction in product or auction for same product or type); end of trading day, week, month, etc. In some embodiments, some or all of the disclosed information may be disclosed to: transacting parties, active auction participants, auction spectators, all users, and/or the street.

In some embodiments, different types of information may be disclosed to different users or groups or types of users at different times. For example, individual users who submitted bids or offers during the auction may learn the volume transacted during the auction or any untransacted volume and/or its buy/sell side before parties qualified to participate in the auction who did not submit bids or offers.

Naturally, information relating to the auctions and parties may be disclosed as needed to comply with all laws and regulations.

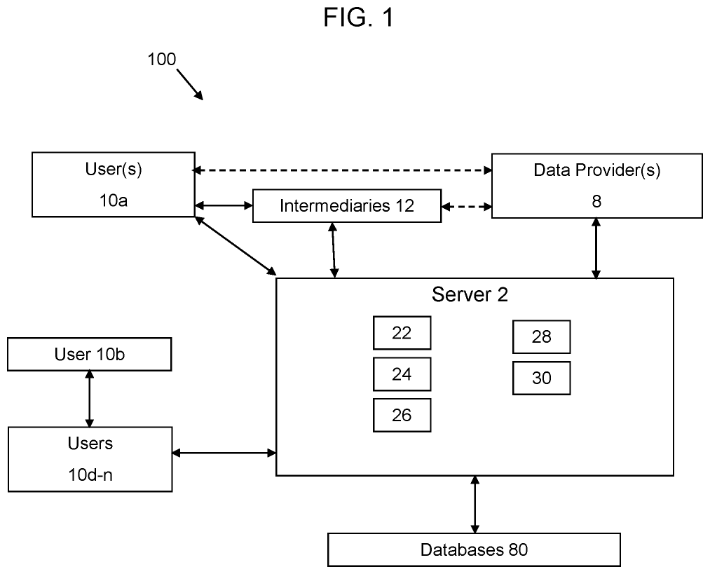

FIG. 1. Exemplary System

Some embodiments of the present invention provide systems and methods for identifying interest, qualifying users, and managing auctions. FIG. 1 depicts a system according to at least one embodiment of the systems disclosed herein. It should be appreciated that various embodiments may alternatively or in addition be configured to operate within the systems described in U.S. patent application Ser. No. 12/113,602 filed May 1, 2008, Ser. No. 12/113,642 filed May 1, 2008, and Ser. No. 12/257,499 filed Oct. 24, 2008.

The system 100 may comprise one or more servers 2 coupled to one or more databases 80, one or more data providers 8a-8n, one or more end users 10a-10n, and one or more agents 12. The data providers 8a-8n, users 10, agents 12, and server 2 may each communicate with each other. In some embodiments, users 10 may also communicate with other users 10.

Server 2 may comprise one or more processors, computers, computer systems, computer networks, and or computer databases. Server 2 may comprise modules 18-64. Server 2 may also comprise one or more databases, such as databases 80. Server 2 may communicate with users 10, data providers 8, and agents 12. For instance, server 2 may communicate with a user 10 computer, such as a browser of a user computer, e.g., over the internet.

Databases 80 may comprise one or more processors, computers, computer systems, computer networks, and/or computer databases configured to store information. Each of databases 80 may communicate with server 2, e.g., via one or more modules of server 2. For instance, server 2 and modules may store information in databases 80 and may also use information stored in databases 80.

Users 10a-10n may comprise one or more human persons, computers, terminals, users, traders, trading entities, or other entities. Users 10 may interact with agents 12, server 2, and/or other users 10. As used in this application, users 10a-10n may also refer to a user's interface to other system 100 components (like server 2), such as a user's PDA or computer or a program running on a user's computer such as a computer web browser like Internet Explorer™, which may communicate with data providers 8, agents 12, and/or server 2.

Data provider(s) 8 may comprise any person, processor, information service, or other entity that publishes or otherwise provides information relating to one or more financial instruments, markets, trading platforms, traders, orders, or other financial- or trade-related information. In some embodiments, the data may include information that may be of interest to or used by a user 10 or server 2.

Data provider 8 may provide information in real time, as information is created or as it first becomes available to the general public, or at another time. Data provider 8 may provide such information in any one or more of a variety of forms and means such as video, audio (e.g., radio broadcast), text (e.g., stock ticker-type information), or other data that may convey information. Data may be provided at a variety of different timings. In some embodiments, data may be provided in periodically, continuously, or continually, e.g., via a data feed (e.g., a stream of data that includes real time updates of trading-related information). In some embodiments, data may be provided after an event, e.g., a trade or submission of an order.

In some embodiments, data provider 8 may provide to server 2 (and/or agents 12 and/or users 10) trading-related information.

Intermediaries 12 may comprise one or more trading-related entities such as a broker, fund manager, or other entity that interacts with users, data providers, and server, but is separate from those entities.

The server 2 may comprise a computer, server, hub, central processor, or other entity in a network, or other processor. The server 2 may comprise input and output devices for communicating with other various system 100 elements. In some embodiments, the server 2 may comprise a trading platform, an exchange, a fund or fund management system, an order matching system, or other processing system.

In some embodiments, the server 2 may be comprised in an end user's computer 10, e.g., as a toolbar in a user's web browser or another program running on the user's computer.

As shown in FIG. 1, the server 2 may comprise a plurality of modules, such as modules 22-34. Each module may comprise a processor as well as input and output devices for communicating with other modules, databases, and other system elements.

User interface module 22 may communicate with users and the server 2.

User interface module 22 may cause information to be output to a user, e.g., at a user output device such as a display device (e.g., a display device at a user terminal), a speaker. The information outputted to a user may be related to a user account, preferences, and other information described herein. User interface module may communicate the information electronically, e.g., via networked communication such as the internet (e.g., in an email or webpage), telecommunication service, etc. In some embodiments, user interface module 22 may comprise input devices for users to communicate trading-related information.

User preferences module 24 may receive, identify, or determine user preferences concerning one or more trading products, counterparties, auction preferences, and other preferences. For instance, the module may receive the preferences from a user interacting with a user interface. The module may also determine them based on a program that automatically determines user preferences concerning one or more securities.

Financial information module 26 may determine financial information associated with one or more orders, trades, counter-parties, auctions, financial instruments, and other financial information.

Search module 28 may search for and/or identify and/or solicit one or more securities, orders, auctions, and/or counter-parties, e.g., concerning one or more orders or auctions. For instance, search module may search one or more financial databases (e.g., a database that stores orders or counter-party preference information), e.g., via the internet, to determine one or more securities or orders that satisfy one or more parameters, such as parameters based on preferences from a user.

Price module 30 may determine and associate one or more values or prices with one or more orders, securities, portfolios, or other financial entities, e.g., as described herein. For instance, price module 30 may determine a price, e.g., for an order, or to be paid to or received by a user or server, e.g., for one or more securities.

Databases

As shown in FIG. 1, a database 80 may be coupled to the server 2. The database 80 may comprise a plurality of databases as described below. Databases 80 may store information about users, elements, and other information.

The modules may function separately or in various combinations. While the modules are shown within a single server, the modules may also operate among several servers. The modules may communicate with a plurality of databases, which may also function collectively or separately.

The modules of server 2 may store, access and otherwise interact with various sources of data, including external data, databases and other inputs.

Exemplary Methods

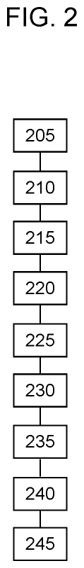

FIG. 2 depicts a flow diagram according to at least one embodiment of the methods disclosed herein.

For each of the flow diagrams of an embodiment of the invention disclosure described below, it should be understood that each function(s) described for each block may be performed using a module capable of performing that function, e.g., according to methods described for each module above. It should also be appreciated that the acts described in these blocks may be performed in any order (including but not limited to the exemplary orderings shown on the diagram), and not all blocks need be performed.

FIG. 2 depicts a flow diagram according to at least one embodiment of the methods disclosed herein.

In block 205, the system may determine that a first user has interest in trading a particular trading product or type. For example, the system may determine that a negotiation to trade the product or a related product has failed. In some embodiments, one or both parties of a failed negotiation may initiate an auction. In some embodiments, there may be unfilled quantity after a trade identified by an OMS. In other embodiments, the system may determine that a user has submitted an order for a trading product that has not yet been fully matched.

In block 210, the system may determine that there is no matching counter-interest in the product or type. For example, the system may determine that the user's order has not been filled, or that a negotiation to trade the product has failed.

In block 215, the system may qualify a subset of users to participate in an auction for the trading product based on each user's portfolio, order history, trade history, or specified interest. For example, the system may invite a plurality of users who have recently traded quantity of the trading product to participate in an auction for the trading product. In some embodiments, the system may notify the users of the auction, e.g., and provide a login or password to enter the auction.

In block 220, the system may determine an auction price for the trading product. In some embodiments, the auction price may be a most recently traded price or a midprice between the best bid and offer in a failed negotiation. The price may be determined by the system, the first user, or a third party.

In block 225, the system may qualify a subset of users to view different types of information throughout the auction process. For example, a user who requested the auction may be entitled to view more information about trades that occurred during the auction than a user who did not participate in the auction.

In block 230, each user may view the trading product, the price, the auction start and end times, and fields for entering a bid or offer volume.

In block 235, the system may start the auction at the designated price for the subset of users. One or more auction participants may submit bids and offers during the auction. Matching bid and offer volume may be matched, e.g., on a first in, first out (FIFO) basis. In some embodiments, other priority rules may be used, such as last in first out (LIFO) matching at the end of the auction. In some embodiments, specific auction participants may have priority over other auction participants. For example, in some embodiments one or more specific users (such as a user who initiated the auction, or the first user to enter buy or sell quantity during the auction) may have the ability to add quantity to an existing order in the auction so that the added quantity has the priority of the existing order; whereas additional quantity added by other users may have a priority according to when that quantity was entered.

In block 240, the system may match and execute all or portions of a bid and offer received before the end of the auction. Matches may occur as quantity can be matched. Trades may occur at the time of matching or at the end of the auction.

In block 245, the system may selectively report auction results and information, e.g., at the end of the auction or during the auction as trades occur. In some embodiments, the existence of buy and sell side interest in the auction may remain confidential to all other users. In some embodiments, the identities of all trading parties may remain anonymous, e.g., indefinitely or until the end of the auction or the execution of a trade with a counterparty.

The system may also identify remaining unmatched quantity on the buy or sell side. The unmatched quantity may be the basis of a “Go Fish” indication of interest submitted into the OMS.

The system may also qualify a subset of users to view different types of information throughout the auction process. For example, a user who requested the auction may be entitled to view more information about trades that occurred during the auction than a user who did not participate in the auction.

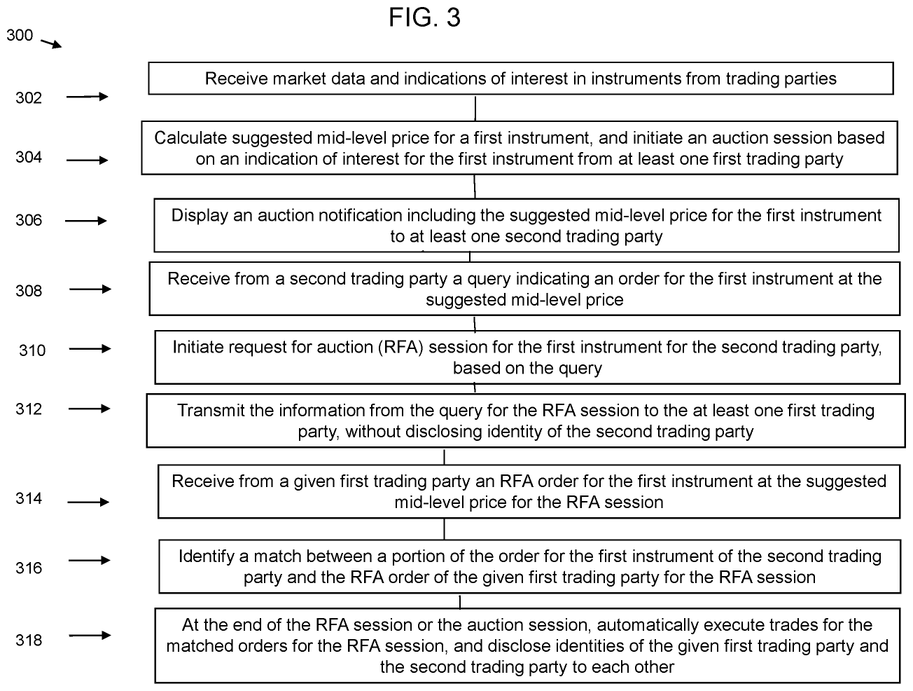

FIG. 3 depicts a flow diagram of a method 300 according to an embodiment of the invention disclosure.

The method 300 may provide for initiation at any time of an auction session for an instrument at a suggested mid-market or mid-level price, where the identities of the counterparties for trades to be executed based on orders matched pursuant to and during the auction session are not disclosed to each other, until after trades are executed for the orders matched during the auction session. A system may determine that first trading parties, such as Sellside trading parties that are subscribers for participation in auction sessions implemented by the system, have an interest in a specific instrument, such as a bond, based on explicit requests from the first trading parties to the system to participate in auction sessions that may arise for a specific instrument, or from requests to participate received from other systems or entities that are affiliated or associated with the first trading parties. In addition, the system may determine a suggested mid-level price for a specific instrument, based on market data received over the communication network indicating prior interest by the first trading party in the specific instrument, for example, prior trades or unfilled orders for the specific instrument of the first trading party. The system may notify second trading parties, such as Buyside trading parties that are subscribers for participation in auction sessions implemented by the system, that an auction session has been initiated for the instrument at the suggested mid-market price, only when there is at least one first trading party determined to have indicated an interest in the instrument. The second trading parties may initiate an RFA session, to obtain the opportunity to solicit liquidity from the first trading parties, which have a known indicated interest in the instrument, such as a bond, at the suggested mid-market price for the instrument. Advantageously, the Sellside subscriber may receive and respond to a targeted solicitation for a specific instrument during an RFA session, and the identity of the Buyside subscriber is not disclosed to the Sellside subscriber until after the RFA session ends and only if a trade has been executed based on an order of the Sellside subscriber submitted during the RFA session.

In some embodiment, Sellside subscribers may agree in writing to have their data used by the system to select certain Sellside subscribers, from those Sellside subscribers that are determined to have indicated an interest in an instrument, to which to route information related to queries from Buyside subscribers to facilitate implementation of an RFA session for the instrument at a suggested mid-level price that results in matching an order for the instrument of a selected Sellside subscriber with at least a portion of an order for the instrument of a Buyside subscriber.

Referring to FIG. 3, in block 302, the server 2 may receive, over a communication network, from data providers 8 and users 10, market data including real time volume match mid-prices for instruments, CLOB bid and offer prices, and information on counterparties that have placed an order, which has been filled or not filled, in a specific financial instrument or type of financial instrument. In one embodiment, the market data may be received from a market data database including one or more servers. Further in block 302, the server 2 may receive, over the communication network, from a first computing device of a first trading party as a Sellside subscriber, a request to receive an auction notification of a RFA session for an instrument, where the request indicates the instrument is of interest to the Sellside subscriber. In addition, the server 2 may receive, over the communication network, from a plurality of first computing device of respective first trading parties as Sellside subscribers, requests to receive an auction notification of a RFA session respectively for many different instruments. The server 2 may store information representative of the requests from respective first trading parties in an OMS in memory.

In block 304, the server 2 may calculate a suggested mid-level price for an instrument, such as a corporate bond, based on the market data from block 302. The suggested mid-level price may be calculated periodically, to provide for an updated suggested mid-level price for an instrument, based on real time changes to the market data. In one embodiment, the suggested mid-level price may be skewed over time away from an observed or generated moving price, for example, as a proportion of the bid-offer spread for the instrument, to increase the probability of execution of a trade for the instrument.

Further in block 304, after the suggested mid-level price is determined, the server 2 may determine whether at least one Sellside subscriber has an interest in the instrument, based on requests to receive an auction notification from Sellside subscribers stored in an OMS. When at least one Sellside subscriber is determined to have indicated an interest in the instrument, the server may initiate an auction session for the instrument. In one embodiment, when the auction session is initiated, the server 2 may control an electronic timer, such as a countdown timer, to time a configurable first time period that is a duration for the auction session. The server 2 may continuously monitor the countdown timer to determine whether the auction session has expired, and when the server 2 determines the auction session has expired due to completion of countdown of the first time period by the countdown timer, terminate the auction session. When the auction session is terminated, as discussed in detail below, the server 2 may terminate any request for auction (RFA) session, which was initiated based on a query indicating an order for the instrument from a second trading party, that is not expired at the time the auction session is terminated. In one embodiment, the auction session may have a duration of six minutes.

In block 306, the server 2, while the auction session has not expired, may display, over the communication network, at displays of computing devices of respective second trading parties as Buyside subscribers, for example, in a pop-up window on a trading display, an auction notification indicating that an RFA session may be initiated for the instrument at the suggested mid-level price.

In block 308, while the auction session has not expired, the computing device of a Buyside subscriber may, based on user interaction with or submission through a graphical user interface of the display of the computing device of the Buyside subscriber, transmit, over the communication network, a query for the instrument at the suggested mid-level price. The query may include direction and size of an order for the instrument at the suggested mid-level price, and identification information identifying the Buyside subscriber that originated the query. In one embodiment, multiple computing devices of respective Buyside subscribers may transmit respective queries for the instrument at the suggested mid-level price, with desired size and direction respectively.

Further in block 308, the server 2 may, over the communication network, receive a query or queries for the instrument at the suggested mid-level price from one or more of the computing devices respectively of Buyside subscribers.

In block 310, while the auction session has not expired, for each query received in block 308, the server 2 may initiate a respective RFA session for a respective Buyside subscriber from which the query originated. The query, in effect, is an on-demand request by the Buyside subscriber, for an auction between the Buyside subscriber and potential Sellside subscribers for the instrument at the suggested mid-level price. The RFA session may have a duration during which an RFA order from a Sellside subscriber at the suggested mid-level price for the instrument may be received and matched to the order for the instrument indicated in the query for the RFA session. The server 2 may control an electronic timer, such as a countdown timer, to time a configurable RFA session time period that is a duration for the RFA session. The server 2 may continuously monitor the countdown timer timing the RFA session time period to determine whether the RFA session has expired, and when the server 2 determines the RFA session has expired due to completion of countdown of the RFA session time period by the countdown timer, terminate the RFA session. For example, the RFA session may have a duration of 90 seconds, such that multiple RFA sessions may be conducted for one or more Buyside subscribers during an auction session. As discussed below, as long as a given RFA session has not expired and the auction session has not expired, the server 2, for the given RFA session, may receive RFA orders of respective Sellside subscribers for the instrument at the suggested mid-level price and match the RFA orders with a portion of the order of a Buyside subscriber that originated the query associated respectively with the given RFA session.

In block 312, while the auction session has not expired and also a given RFA session has not expired, the server 2 may transmit, over the communication network, RFA session information corresponding to the query for the given RFA session to a computing device of one or more Sellside subscribers determined in block 304 to have submitted an indication of interest in the instrument of the given RFA session, to effectuate smart order routing of the query. In one embodiment, all of the one or more Sellside subscribers determined in block 304 to have submitted an indication of interest in the instrument of the given RFA session may be provided with the RFA session information. The RFA session information may indicate the suggested mid-level price for the instrument, and preferably does not disclose a size and a direction of the order indicated in the query for the RFA session, and an identity of the Buyside subscriber from which the query for the RFA session originated. The transmission of the RFA session information may cause display of the RFA session information on displays of respective computing devices of the Sellside subscribers. The server 2 may control display of the RFA session information at the computing devices of the Sellside subscribers to display the RFA session information only while the server 2 determines that the corresponding RFA session is not expired and also the auction session associated with the RFA session is not expired.

In one embodiment, in the event multiple Buyside subscribers submit respective queries for the same instrument during an auction session, the server 2 may initiate multiple auction sessions at the same time and cause display of RFA session information for the respective RFA sessions at a display of a computer of a Sellside subscriber as respective multiple independent line items.

In one embodiment, the server 2 may perform a smart order router processing to determine selected Sellside subscribers, of a group of Sellside subscribers determined in block 304 to have indicated an interest in a specific instrument, to which to transmit RFA session information indicated by a query. In one embodiment the server 2 may select the selected Sellside subscribers by determining, from trading information concerning Sellside subscribers stored in a memory, those Sellside subscribers that previously indicated an interest in the instrument that is the same instrument indicated in the query for the instrument at the suggested mid-level price by a Buyside subscriber and furthermore satisfy other criteria. In one embodiment, the smart order routing processing may include further filtering selected Sellside subscribers from a group of Sellside subscribers determined in block 304, based on a variety of factors other than the indication of interest in the instrument, such as those described in connection with the flow diagram of FIG. 2, and in some embodiments, venue of a Sellside subscriber.

In block 314, the computing device of a Sellside subscriber may, based on user interaction with or a submission through a graphical user interface of the display of the computing device of the Sellside subscriber, transmit, over the communication network, an RFA order indicating an interest to trade the instrument at the suggested mid-level price indicated by the RFA session information. The RFA order may include an order to buy or sell and a target size. In one embodiment, multiple computing devices of respective Sellside subscribers may transmit RFA orders for the same instrument at the suggested mid-level price for a same RFA session or different RFA sessions. Further in block 314, the server 2 may, over the communication network, receive the RFA orders for the same instrument at the suggested mid-level price from the multiple computing devices of respective Sellside subscribers. The operations of block 314 discussed above may only be performed for an RFA session so long as that RFA session has not expired, and also the auction session for the instrument at the suggested mid-level price associated with the RFA session has not expired.

In one embodiment, the RFA orders may be processed as orders to complete a trade in the instrument at the suggested mid-level price at a side opposite to a side indicated in the query from the Buyside subscriber corresponding to the RFA session. The RFA orders may be treated as valid and to be automatically matched to at least a portion of an order a Buyside subscriber, while an RFA session with which the RFA order is associated has not expired and the auction session during which the RFA session was initiated has not expired.

In one embodiment, for a particular RFA session, the server 2 may receive information identifying size and direction of the order constituting the RFA order from the Sellside subscriber, and not disclose such Sellside subscriber information and also the identity of the Sellside subscriber, to a Buyside subscriber for the particular RFA session before trades are executed on matched orders for the particular RFA session.

In block 316, while the auction session has not expired and a respective RFA session has not expired, the server 2 may identify and match offsetting orders of a same size for the instrument at the suggested mid-level price for the RFA session, based on the Buyside subscriber query and Sellside subscriber(s) RFA order(s) for the RFA session. In one embodiment, Buyside and Sellside subscribers, in advance, may agree that trades are automatically executed for orders matched for an RFA session, such that after the RFA session is expired or the auction session is expired, matched orders may be executed as respective trades without further communication among the server 2 and the Buyside and Sellside subscribers' computing devices. The agreement to automatically execute a trade for matched orders in an auction session advantageously provides that processing and memory resources, and communication bandwidth usage, may be reduced, while obtaining an increased number of executed trades, and thus increased liquidity, especially for a financial instrument that is less liquid, such as a bond.

In one embodiment, while the auction session has not expired and a respective RFA session has not expired, when the server 2 identifies matching orders for an instrument for the RFA session, the server 2 may cause display, on displays of computing devices of the Buyside subscriber and Sellside subscribers associated with orders for the instrument in the RFA session, of indicia, such as a gavel symbol, to alert the Buyside subscriber and Sellside subscribers that matched orders of the order and the RFA order have been identified for the respective RFA session.

In one embodiment, the server 2 may store in the memory each RFA order with a time stamp indicating time of receipt of the RFA order at the server 2, and generate in the memory a queue of the RFA orders in time priority order by time of receipt. Also, the server 2 may display RFA orders in the queue on a display of a subscriber's computing device to indicate the time priority order of RFA orders for potential order matching. The server 2 may attempt to match respective RFA orders in the queue in time priority order with at least a portion of an order from the Buyside subscriber for a corresponding RFA session, and display the matched orders on a display of a Buyside subscriber computing device that originated an order having at least a portion thereof matched with an RFA order.

In one embodiment, during an RFA session, the Sellside subscriber may amend an RFA order at the computing device thereof, and transmit from the computing device thereof to the server 2, over the communication network, order amendment information indicating an amendment to the RFA order, such as to size or direction or both. The server 2 may receive the RFA order amendment information and determine based on the order amendment information whether an initial size of the RFA order is the same or less than previous. When the server 2 determines the initial size of the RFA order is the same size or a smaller size than previous, the server may maintain the size of an RFA order in its position in the priority queue and change only its size, as suitable. In the event the server 2 determines that the order amendment information indicates to add additional size to the RFA order, the server 2 may create a new RFA order for the additional size and position the new RFA with the additional size as the latest entry in the queue, such that the new RFA order becomes the last RFA order in the time priority order of the queue, based on time of receipt of the order amendment information at the server 2.

In one embodiment, when the order amendment information indicates a change in the direction to an existing RFA order, when the existing RFA order is not matched, the server 2 may cancel the existing RFA, order and generate a new RFA order and add the new RFA order as a last RFA order in time priority order of the queue, based on time of receipt of the order amendment information at the server 2. In addition, in the event the existing RFA order has been matched when the order amendment information indicating a change in the direction to an existing RFA order is received at the server 2, the server 2 may ignore the order amendment information or, alternatively, generate a new RFA order and add the new RFA order as last RFA order in time priority order of the queue, based on time of receipt of the order amendment information at the server 2.

In one embodiment, a Buyside or Sellside subscriber, for which an order for a particular instrument at the suggested mid-level price associated with an RFA session is unmatched during an RFA session, may, at any time during the RFA session and while the auction session is unexpired, transmit, over the communication network, a withdraw message to the server 2. Based on receipt of a withdraw message from a Buyside subscriber transmitted while the auction session is unexpired, the server 2 may determine whether any RFA order from any Sellside subscriber is matched at least partially to the order of the Buyside subscriber for the RFA session. When the server 2 determines that a match of at least a portion of the order with any RFA order from any Sellside subscriber is not identified, the server 2 may terminate the RFA session for the particular Buyside subscriber. In one embodiment, based on receipt of a withdraw request from the Buyside subscriber, the server 2 may facilitate execution of any matched RFA orders and not initiate any new RFA session based on a newly received query from a Buyside subscriber. When the server 2 determines that a match of at least a portion of the order with any RFA order from any Sellside subscriber is identified, the server 2 may not terminate the RFA session of the Buyside subscriber.

Based on receipt from a Sellside subscriber of a withdraw RFA order request for a particular RFA order for a particular RFA session transmitted while the particular RFA session and the auction session have not expired, the server 2 may determine whether the particular RFA order for the particular RFA session is matched to at least a portion of an order for the particular RFA session. When the server 2 determines a match between at least a portion of the order for the particular RFA session and the particular RFA order does not exist, the server 2 may remove the particular RFA order from a queue of orders for the Sellside subscriber in the particular RFA session. When the server determines a match between at least a portion of the order for the particular RFA session and the particular RFA order exists, the server 2 may ignore the withdraw RFA order request for the particular RFA order, such that matched trades of the particular RFA order and at least a portion of the order are maintained and executed after the auction session or the particular RFA session is terminated.

In block 318, the server 2 may determine whether the countdown timer timing the time period of an RFA session or the auction session has expired. When the server 2 determines the RFA session has expired and the auction session has not expired, the server 2 may automatically facilitate execution of trades corresponding respectively to all matched orders for the RFA session. When the server 2 determines the RFA session has not expired and the auction session has expired, the server 2 may automatically facilitate execution of trades corresponding respectively to all matched orders thus far for the RFA session. Following execution of the matched trades, the server 2 may disclose, along with size and direction information for the matched trades, the names of the subscribers whose orders were matched and resulted in execution of a trade, to the opposing counterparty subscribers.

In addition, when the server 2 determines that an RFA session has expired, or the RFA session has not expired but the auction session associated with RFA session has expired, the server 2 may cancel all unmatched orders for the RFA session.

In one embodiment, when the RFA session has expired or is terminated by virtue of expiration of the auction session, the server 2 may not disclose any residual unfilled size of an order for an instrument to any Sellside subscriber or Buyside subscriber or otherwise to the marketplace.

In one embodiment, the server 2 may generate two trades respectively for two matched orders of a RFA session, and the system may act as a counterparty to both of the trades. For example, for two matched orders in a RFA session including an RFA order of a Sellside subscriber and a portion of an order of a Buyside subscriber, a first trade may be for a portion of a bid order of a Buyside subscriber where the system is a counter party in the first trade, and a second trade may be for an offer order corresponding to the RFA order where the system is a counter party in the second trade.

In one embodiment, the server 2 may periodically determine a suggested mid-level price for a specific instrument. For each suggested mid-level price that is calculated, the server 2 may perform operations to initiate an auction session and facilitate execution of trades for a specific instrument at the calculated mid-level price based on matched trades during an RFA session, similarly as described in connection with the method of FIG. 3.

In some embodiments, auction sessions, such as described in the exemplary method of FIG. 3, may be performed sequentially, such that a new auction session is not initiated until termination of a previously initiated auction session. In some embodiments, multiple auction sessions, each starting at a different time, may be performed simultaneously.

In some embodiments, the implementation of the functionalities of an auction session during which multiple RFA sessions may be conducted for respective trading parties as described above in connection with FIG. 3 may be fully integrated into an existing electronic trading platform of a Buyside subscriber and a Sellside subscriber.

Various embodiments may be configured to work with and use various features of the Order Management System and other elements described in U.S. patent application Ser. No. 12/113,602 filed May 1, 2008, Ser. No. 12/113,642 filed May 1, 2008, and Ser. No. 12/257,499 filed Oct. 24, 2008, which are incorporated herein by reference in their entireties. In particular, various embodiments may use the systems, software, and methods relating to the “Go Fish” method of detecting and matching interest in buying or selling one or more financial instruments. It should be appreciated that in some embodiments, a distributed system of detection and matching may enable each user's workstation to determine whether that user has interest that matches other interest (e.g., such that the user is (or is not) made aware of the existence and/or source of the matching interest). In other embodiments, a central server may aggregate user interest information and identify potentially matching interest. Accordingly, it should be appreciated that detecting interest, qualifying users to view interest and/or participate in an auction, matching interest and counter-interest, and executing orders may use a distributed or centralized system.

It should be appreciated that the term “auction” may refer to any type of auction, including the “Volume Match” type auction offered by products such as BGC Trader and/or BGC Broker (offered via BGC Partners, Inc.). Accordingly, various embodiments described herein may use Volume Match style auctions as used in these past and present Volume Match style auctions.

In some of the “Volume Match” style auctions that may be used in conjunction with various embodiments of the present invention, a suggested price for the trading product is determined and disclosed to users in advance of the auction. During the auction, participating users may submit buy quantities and sell quantities via an interface. The system matches bid quantities against offer quantities at the designated price on a First In, First Out (FIFO) basis. A user may submit multiple bids and offers. The auction may fill some, none, or all of the user's order(s), depending on the extent of the counter interest and the extent of orders ahead of the user's order in time priority. Users may be notified (e.g., at the end of the auction) if and/or when their bid or offer is matched and executed against one or more contra orders in the auction. Users are able to view their own orders during the auction. However, in some embodiments, users may not be able to view some or all information about other orders in the auction, such as the buy/sell side of other orders.

During the auction, users and brokers may view different information about the same auction, as users may not be qualified to view information about the identity of other users, e.g., until after the auction. More detail about Volume Match is available online and in the Appendix to a Provisional Patent Application entitled “SYSTEMS AND METHODS FOR DETECTING INTEREST AND VOLUME MATCHING,” which is incorporated herein by reference.

It should further be appreciated that while various embodiments discuss Volume Match style auctions, other systems and methods, auctions, and matching mechanisms may be used to match and execute orders and counter-orders for a particular trading product.

The disclosures of the above-identified applications, and all other patent applications and other documents referenced in this patent application, are incorporated by reference herein in their entireties.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

What is claimed is:

1. A method of managing an auction for trading an instrument, the method comprising:
controlling, by at least one processor:
receiving, over a communication network, from a market data database, market data including filled and unfilled order information for a first instrument and, from computing devices of respective trading parties, an indication of interest in the first instrument and an indication of interest in at least one other instrument;
determining a suggested mid-level price for the first instrument for an auction session;
initiating an auction session for a first time period, based on a determination that an indication of interest in the first instrument of at least one first trading party of the trading parties is received over the communication network respectively from at least one first computing device of the computing devices;
monitoring countdown by a first electronic timer of the first time period;
while the auction session is determined not to be expired as indicated by the countdown of the first time period,
displaying, over the communication network, at a display of at least one second computing device of at least one second trading party, an auction notification for the first instrument at the suggested mid-level price;
receiving, over the communication network, from a given second computing device of the at least one second computing device, a query of a given second trading party responsive to the auction notification, in which the query indicates an order for the first instrument indicating a size and direction of the order;
responsive to receiving the query, initiating a request for auction (RFA) session for the given second trading party for a second time period shorter than the first time period;
monitoring countdown by a second electronic timer of the second time period;
while the RFA session for the given second trading party is determined not to be expired as indicated by the countdown of the second time period,
displaying, over the communication network, at a display of the at least one first computing device, RFA session information indicated by the query, in which the RFA session information indicates the first instrument and the suggested mid-level price for the RFA session for the given second trading party without indicating the size of the order, the direction of the order and identity of the given second trading party;
receiving, over the communication network, from a given first computing device of the at least one first computing device, an RFA order of a given first trading party to trade the first instrument in the RFA session for the given second trading party, in which the RFA order indicates a second size and a second direction; and
identifying matched orders including at least a portion of the order and the RFA order; and
following execution of the matched orders, displaying, over the communication network, at the displays respectively of the given first computing device and the given second computing device, trade execution information for the matched orders indicating respectively identities of the given second trading party and the given first trading party.

2. The method of claim 1, in which the at least one second computing device includes a plurality of second computing devices respectively of a plurality of second trading parties, the method further comprising:
controlling, by the at least one processor:
while the auction session is determined not to be expired,
receiving, over the communication network, from given second computing devices of the plurality of second computing devices, a plurality of first queries respectively of given second trading parties responsive to the auction notification, in which each of the first queries indicates a first order for the first instrument indicating a first size and a first direction of the first order;
responsive to receiving the first queries, initiating first RFA sessions respectively for the given second trading parties for given second time periods shorter than the first time period;
monitoring countdown by given second electronic timers respectively of the given second time periods;
while a given first RFA session of the first RFA sessions for a given first order of one of the given second trading parties is determined not to be expired as indicated by the countdown of a corresponding given second time period,
displaying, over the communication network, on the display of the at least one first computing device, given first RFA session information corresponding to the given first RFA session, in which the given first RFA session information indicates the first instrument and the suggested mid-level price for the given first RFA session without indicating a given first size of the given first order, a given first direction of the given first order and identity of the corresponding one of the given second trading parties,
in which first RFA session information respectively for the first RFA sessions are represented as independent line items on the display of the at least one first computing device.

3. The method of claim 1, in which the at least one first computing device includes a plurality of first computing devices respectively of a plurality of first trading parties, the method further comprising:
controlling, by the at least one processor, while the RFA session for the given second party and the auction session are determined not to be expired,
receiving, over the communication network, from given first computing devices of the plurality of first computing devices, first RFA orders respectively of given first trading parties to trade the instrument in the RFA session, in which each of the first RFA orders indicates a given second size and a given second direction; and
identifying matched orders including at least a portion of the order and a respective one of the first RFA orders.

4. The method of claim 3, in which the matched orders are determined in time priority order based on time of receipt of the first RFA orders.

5. The method of claim 1, further comprising:
controlling, by the at least one processor:
maintaining a queue in which given RFA orders from given first computing devices of the at least one first computing device are arranged in time priority order based on time of receipt thereof by the at least one processor.

6. The method of claim 1, further comprising:
controlling, by the at least one processor, while the RFA session and the auction session are determined not to be expired,
displaying, over the communication network, on the displays respectively of the given first computing device and the given second computing device, alerting indicia indicating identification of a match of the at least the portion of the order and the RFA order.

7. The method of claim 1, further comprising:
controlling, by the at least one processor, while the RFA session and the auction session are determined not to be expired:
receiving, over the communication network, from the given second computing device, a withdraw RFA session request;
determining whether any RFA order from any of the at least one first computing device is matched at least partially to the order;
when a determination is that a match of at a portion of the order and any RFA order from any of the at least one first computing device is not identified, terminating the RFA session.

8. The method of claim 1, further comprising:
controlling, by the at least one processor, while the RFA session and the auction session are determined not to be expired:
receiving, over the communication network, from the given first computing device, a withdraw RFA order request for the RFA session for a third RFA order of the given first trading party;
determining whether the third RFA order for the RFA session is matched to at least a portion of the order; and
when a match between at least a portion of the order and the third RFA order is determined not to exist, removing the third RFA order from a queue of orders for the given first trading party in the RFA session.

9. The method of claim 1, further comprising:
controlling, by the at least one processor, when the auction session is determined to be expired,
executing the matched orders at a third computing device.

10. The method of claim 9, wherein the executing includes transmitting, over the communication network, to the third computing device of a third party, a trade execution request for the RFA order and the at least a portion of the order, in which the trade execution request indicates a first trade for the at least the portion of the order and a second trade for the RFA order, and in which the third party is a counterparty to each of the first trade and the second trade.

11. The method of claim 1, wherein the at least one first trading party is a Sellside trading party and the at least one second trading party is a Buyside trading party.

12. A system of managing an auction for trading an instrument, the system comprising:
at least one processor configured to control:
receiving, over a communication network, from a market data database, market data including unfilled and filled order information for a first instrument and, from computing devices of respective trading parties, an indication of interest in the first instrument and an indication of interest in at least one other instrument;
determining a suggested mid-level price for the first instrument for an auction session;
initiating an auction session for a first time period, based on a determination that an indication of interest in the first instrument of at least one first trading party of the trading parties is received over the communication network respectively from at least one first computing device of the computing devices;
monitoring countdown by a first electronic timer of the first time period;
while the auction session is determined not to be expired as indicated by the countdown of the first time period,
displaying, over the communication network, at a display of at least one second computing device of at least one second trading party, an auction notification for the first instrument at the suggested mid-level price;
receiving, over the communication network, from a given second computing device of the at least one second computing device, a query of a given second trading party responsive to the auction notification, in which the query indicates an order for the first instrument indicating a size and direction of the order;
responsive to receiving the query, initiating a request for auction (RFA) session for the given second trading party for a second time period shorter than the first time period;
monitoring countdown by a second electronic timer of the second time period;
while the RFA session for the given second trading party is determined not to be expired as indicated by the countdown of the second time period,
displaying, over the communication network, at a display of the at least one first computing device, RFA session information indicated by the query, in which the RFA session information indicates the first instrument and the suggested mid-level price for the RFA session for the given second trading party without indicating the size of the order, the direction of the order and identity of the given second trading party;
receiving, over the communication network, from a given first computing device of the at least one first computing device, an RFA order of a given first trading party to trade the first instrument in the RFA session for the given second trading party, in which the RFA order indicates a second size and a second direction; and
identifying matched orders including at least a portion of the order and the RFA order; and
following execution of the matched orders, displaying, over the communication network, at the displays respectively of the given first computing device and the given second computing device, trade execution information for the matched orders indicating respectively identities of the given second trading party and the given first trading party.

13. The system of claim 12, in which the at least one second computing device includes a plurality of second computing devices respectively of a plurality of second trading parties, and
in which the at least one processor is configured to control:
while the auction session is determined not to be expired,
receiving, over the communication network, from given second computing devices of the plurality of second computing devices, a plurality of first queries respectively of given second trading parties responsive to the auction notification, in which each of the first queries indicates a first order for the first instrument indicating a first size and a first direction of the first order;
responsive to receiving the first queries, initiating first RFA sessions respectively for the given second trading parties for given second time periods shorter than the first time period;
monitoring countdown by given second electronic timers respectively of the given second time periods;
while a given first RFA session of the first RFA sessions for a given first order of one of the given second trading parties is determined not to be expired as indicated by the countdown of a corresponding given second time period,
displaying, over the communication network, on the display of the at least one first computing device, given first RFA session information corresponding to the given first RFA session, in which the given first RFA session information indicates the first instrument and the suggested mid-level price for the given first RFA session without indicating a given first size of the given first order, a given first direction of the given first order and identity of the corresponding one of the given second trading parties,
in which first RFA session information respectively for the first RFA sessions are represented as independent line items on the display of the at least one first computing device.

14. The system of claim 12, in which the at least one first computing device includes a plurality of first computing devices respectively of a plurality of first trading parties, and
in which the at least one processor is configured to control:
while the RFA session for the given second party and the auction session are determined not to be expired,
receiving, over the communication network, from given first computing devices of the plurality of first computing devices, first RFA orders respectively of given first trading parties to trade the instrument in the RFA session, in which each of the first RFA orders indicates a given second size and a given second direction; and
identifying matched orders including at least a portion of the order and a respective one of the first RFA orders.

15. The system of claim 14, in which the matched orders are determined in time priority order based on time of receipt of the first RFA orders.

16. The system of claim 12, in which the at least one processor is configured to control:
maintaining a queue in which given RFA orders from given first computing devices of the at least one first computing device are arranged in time priority order based on time of receipt thereof by the at least one processor.

17. The system of claim 12, in which the at least one processor is configured to control:
while the RFA session and the auction session are determined not to be expired,
displaying, over the communication network, on the displays respectively of the given first computing device and the given second computing device, alerting indicia indicating identification of a match of the at least the portion of the order and the RFA order.

18. The system of claim 12,
in which the at least one processor is configured to control:
while the RFA session and the auction session are determined not to be expired:
receiving, over the communication network, from the given second computing device, a withdraw RFA session request;
determining whether any RFA order from any of the at least one first computing device is matched at least partially to the order;
when a determination is that a match of at a portion of the order and any RFA order from any of the at least one first computing device is not identified, terminating the RFA session.

19. The system of claim 12, in which the at least one processor is configured to control:
while the RFA session and the auction session are determined not to be expired:
receiving, over the communication network, from the given first computing device, a withdraw RFA order request for the RFA session for a third RFA order of the given first trading party;
determining whether the third RFA order for the RFA session is matched to at least a portion of the order; and
when a match between at least a portion of the order and the third RFA order is determined not to exist, removing the third RFA order from a queue of orders for the given first trading party in the RFA session.

20. The system of claim 12, in which the at least one processor is configured to control:
when the auction session is determined to be expired, executing the matched orders at a third computing device.
